(19) United States
(12) Patent Application Publication
(10) Pub. No.: US 2018/0225948 A1
(43) Pub. Date: Aug. 9, 2018

(54) IOT INTEGRATED TYPE DATA PROCESSOR FOR INTERFACING WITH WIRED AND WIRELESS FACILITIES

(71) Applicant: KDT CO., LTD., Chuncheon-si (KR)

(72) Inventors: Young Bok KWEON, Seongnam-si (KR); Sung Bum JOO, Chuncheon-si (KR)

(73) Assignee: KDT CO., LTD., Chuncheon-si (KR)

(21) Appl. No.: 15/854,761

(22) Filed: Dec. 27, 2017

(30) Foreign Application Priority Data
Feb. 7, 2017 (KR) 10-2017-0016788

(51) Int. Cl. G08B 21/18

(52) U.S. Cl. CPC G08B 21/185; H04L 67/12

(57) ABSTRACT

An IoT integrated type data processor for interfacing with wired and wireless facilities is disclosed. The IoT integrated type data processor includes a main body, to which external power and data cables are connected, a communication unit selectively coupled to the main body for wirelessly transmitting and receiving data, and a coupling unit for seperably coupling the main body and the communication unit to each other or seperably coupling communication modules constituting the communication unit to each other. The IoT integrated type data processor has the following effects. First, it is possible for the user to recognize the inner state of the power device in real time, whereby it is possible to rapidly respond to an emergency. Second, it is possible to selectively use the communication modules depending on the location of the power device and the distance between the power device and the user, whereby it is possible to reduce expenses. Third, it is possible to selectively adapt to the user's environment by varying the kinds of communication modules that are included, whereby it is possible to improve assemblability. Fourth, it is possible for the data processor to be easily coupled to or separated from the power device or to achieve easy coupling or separation between the main body and the communication unit.

This application claims the benefit of Korean Patent Application No. 10-2017-0016788, filed on Feb. 7, 2017, which is hereby incorporated by reference as if fully set forth herein.

### BACKGROUND OF THE INVENTION

### Field of the Invention

The present invention relates to a data processor, and more particularly to an IoT integrated type data processor for interfacing with wired and wireless facilities that is capable of transmitting to a user the operational state of a power device, such as a primary distribution panel or a secondary distribution panel, distant from a work area using long-distance or short-distance wireless communication.

### Discussion of the Related Art

In general, a power device is a name commonly used to refer to a primary distribution panel, a secondary distribution panel, a supply and distribution panel, a low-voltage panel, a high-voltage panel, a transformer panel, and the like. Principally, the power device is a device including a breaker or a power element, such as a magnet, for allowing, blocking, or controlling the supply of external power.

Among the above-mentioned power devices, the secondary distribution panel, which is the most widely used in the industrial field, is variously installed depending on the power capacity required for various kinds of switches, gauges, relays, and the like to operate or control a power plant or a substation or to operate a motor. The secondary distribution panel mainly distributes external power through wiring in a building or the like to supply the power to respective elements in the building or the like, and in addition to allow or block the supply of the power.

A representative power device including such a secondary distribution panel includes a plurality of frames for supporting a load and a plurality of panels for covering the frames. Various kinds of electronic equipment are included in the power device such that the electronic equipment is protected from the external environment.

However, most conventional power devices are distant from a work area or a place where a user resides. For this reason, the ability to inspect various dangerous factors generated in the power devices in detail is limited.

Moreover, the power devices have a water-leakage problem, and are not sufficiently ventilated. As a result, the power devices may malfunction or catch fire due to condensation. In the dry season, arcs may be generated in the power devices, with the result that the power devices may catch fire. In addition, when a fire occurs in the power devices, when abnormal current or voltage is generated in the power devices, or when an earthquake occurs, it is possible to recognize such problems and dangerous states only after a predetermined time.

### SUMMARY OF THE INVENTION

Accordingly, the present invention is directed to an IoT integrated type data processor for interfacing with wired and wireless facilities that substantially obviates one or more problems due to limitations and disadvantages of the related art.

An object of the present invention is to provide an IoT integrated type data processor for interface between a user (i.e. a worker) and wired and wireless facilities.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an IoT integrated type data processor for interfacing with wired and wireless facilities includes a main body, to which external power and data cables are connected, a communication unit selectively coupled to the main body for wirelessly transmitting and receiving data, and a coupling unit for seperably coupling the main body and the communication unit to each other or seperably coupling communication modules constituting the communication unit to each other.

The main body may be mounted in a power device to receive data, such as temperature, humidity, arc, current, voltage, fire, and earthquakes in the power device and to transmit the data to the communication unit.

The communication unit may include at least one selected from among a first communication module using one selected from among an RS-232 interface, an RS-422 interface, and an RS-485 interface, a second communication module using a Wireless-Fidelity (Wi-Fi) interface, a third communication module using a Code Division Multiple Access (CDMA) interface, a fourth communication module using a Bluetooth interface, and a fifth communication module using a ZigBee interface.

The coupling unit may include a hook unit protruding from one side surface of one selected from between the main body and any one of the communication modules and a coupling recess formed in a corresponding side surface of the other selected from between the main body and any one of the communication modules such that the hook unit is fastened into the coupling recess.

The hook unit may include a hook member protruding toward the coupling recess, a button member for slidably moving the hook member such that the hook member is coupled into the coupling recess or separated from the coupling recess, and a cover member for covering the button member such that the button member can be pushed only when the hook member is to be coupled into the coupling recess or is to be separated from the coupling recess.

The coupling unit may include a guide member protruding from one side surface of one selected from between the main body and any one of the communication modules and a guide recess provided in a corresponding side surface of the other selected from between the main body and any one of the communication modules for guiding coupling between the main body and any one of the communication modules.

The IoT integrated type data processor may further include a female port provided at one side surface of one selected from between the main body and any one of the communication modules and a male port provided at a corresponding side surface of the other selected from between the main body and any one of the communication modules such that the male port is coupled to the female port, wherein, when the guide member is coupled into the guide recess, the male port may be simultaneously connected to the female port.

Each of the main body and the communication modules may include a fastening unit provided at the lower surface thereof such that each of the main body and the communication modules is temporarily fixed to an installation position.

The fastening unit may be configured to integrally fasten the main body and the communication modules, integrally coupled to each other through the coupling unit, to the installation position.

Each of the main body and the communication modules may include a display unit for displaying an operable state or an inoperable state thereof.

The main body may be configured to receive data transmitted to the communication unit from the outside and to transmit a control signal corresponding thereto to a controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view showing an Internet-of-Things (IoT) integrated type data processor for interfacing with wired and wireless facilities according to an embodiment of the present invention;

FIG. 2 is an exploded perspective view showing the IoT integrated type data processor for interfacing with wired and wireless facilities shown in FIG. 1;

FIG. 3 is an exploded view showing a main body of the IoT integrated type data processor for interfacing with wired and wireless facilities shown in FIG. 1;

FIG. 4 is a reference view showing the interior of a portion of a communication unit of the IoT integrated type data processor for interfacing with wired and wireless facilities shown in FIG. 1; and

FIG. 5 is an exploded view showing the portion of the communication unit of the IoT integrated type data processor for interfacing with wired and wireless facilities shown in FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In the following description of the present invention, a detailed description of known functions and configurations incorporated herein will be omitted when it may obscure the subject matter of the present invention. In addition, some features shown in the drawings are enlarged, reduced, or simplified for convenience of description, and components are not necessarily shown at appropriate ratios in the drawings, which will be easily understood by those skilled in the art.

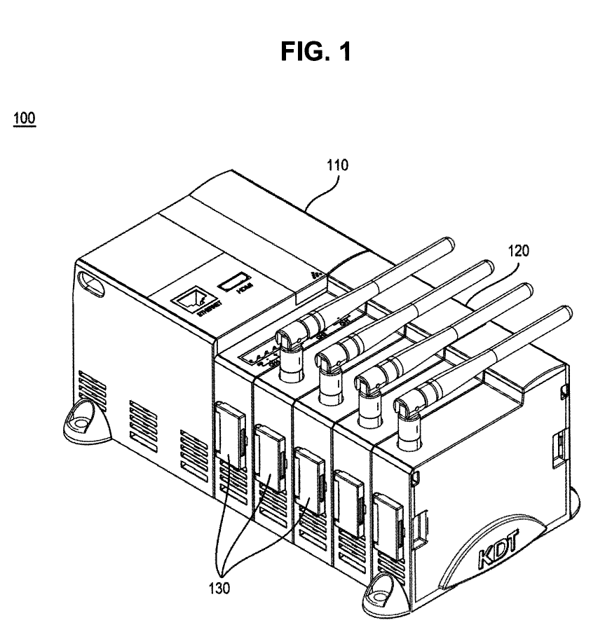

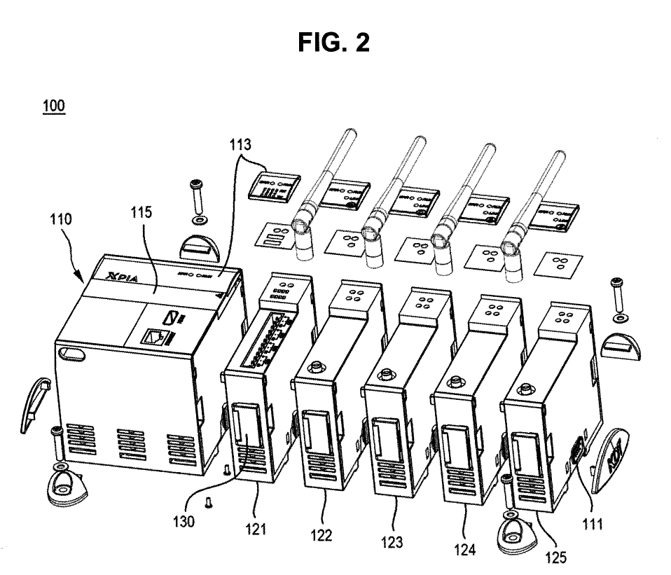

FIG. 1 is a perspective view showing an Internet-of-Things (IoT) integrated type data processor for interfacing with wired and wireless facilities according to an embodiment of the present invention, and FIG. 2 is an exploded perspective view showing the IoT integrated type data processor for interfacing with wired and wireless facilities shown in FIG. 1.

The IoT integrated type data processor for interfacing with wired and wireless facilities according to the embodiment of the present invention, denoted by reference numeral 100, includes a main body 110 disposed in a power device (not shown), a communication unit 120 selectively coupled to the main body 110 for wirelessly transmitting and receiving data, and a coupling unit 130 for seperably coupling the main body 110 and the communication unit 120 to each other or seperably coupling communication modules 121, 122, 123, 124, and 125 constituting the communication unit 120 to each other.

The power device may be at least one selected from among a primary distribution panel, a supply and distribution panel, a secondary distribution panel, a motor control panel, and a solar light connection panel.

External power and data cables are connected to the main body 110. Consequently, the main body 110 may receive data, such as information about temperature, humidity, arcs, current, voltage, and fire in the power device. In addition, the main body 110 may receive data about an earthquake, if the same occurs. Although not shown, a sensor or a measuring instrument is provided to acquire such data.

An external Ethernet cable may be connected to the main body 110, or a universal serial bus (USB) port may be provided in the main body 110.

The communication unit 120 includes a first communication module 121 using one selected from among an RS-232 interface, an RS-422 interface, and an RS-485 interface, a second communication module 122 using a Wireless-Fidelity (Wi-Fi) interface, a third communication module 123 using a Code Division Multiple Access (CDMA) interface, a fourth communication module 124 using a Bluetooth interface, and a fifth communication module 125 using a ZigBee interface.

When the communication unit 120 is coupled to the main body 110, one or more of the first to fifth communication modules 121 to 125 may be coupled to the main body 110 for convenience in communication depending on the location of the power device and the distance between the power device and a user.

The first communication module 121 uses one selected from among RS-232, which is one of the serial communication standards, RS-259, which is a high-output radio frequency (RF) connector-related standard, RS-422, which is a data series transmission standard, RS-423, which is an unbalanced series interface standard, and RS-485, which is an upgraded version of RS-232 and RS-422 and is a kind of serial communication protocol standard for supporting home networking.

The second communication module 122 uses IEEE 802.11, which is a normal wireless Local Area Network (LAN) standard and is commonly referred to as Wi-Fi. One of a, b, g, n, and ac versions of IEEE 802.11 may be selectively used depending on transmission speed and transmission distance.

The third communication module 123 uses a CDMA interface. Alternatively, a Time Division Multiple Access (TDMA) interface may be used depending on the region in which the third communication module 123 is used (locale or country).

The fourth communication module 124 uses Bluetooth, which is near field communication. The fourth communication module 124 may be used when the distance to the user is short.

The fifth communication module 125 uses ZigBee, which is one of IEEE 802.15.4 standards for supporting short-distance communication. This type of communication supports short-distance communication within a distance of about 10 to 20 mm and ubiquitous computing. Consequently, the fifth communication module 125 may be used when short-distance communication is possible within a longer distance than the fourth communication module 124.

The communication unit 120 may enable data, transmitted to the main body 110 from a controller (not shown) installed in the power device, to be transmitted to the user. Additionally, the user may transmit a control signal to the communication unit 120 such that the controller performs remote control in response to the control signal.

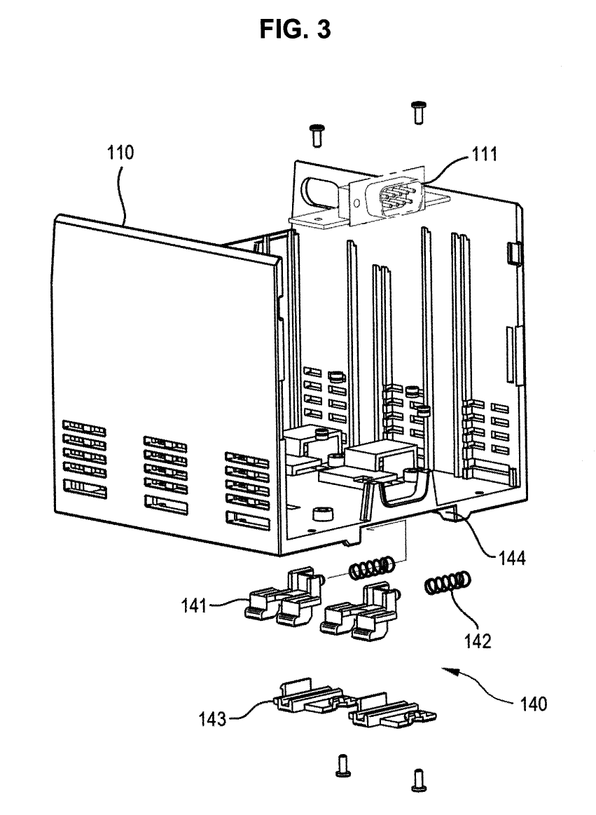

FIG. 3 is an exploded view showing the main body of the IoT integrated type data processor for interfacing with wired and wireless facilities shown in FIG. 1.

Referring to FIG. 3, slots, into which a power printed circuit board (PCB) and a central processing unit (CPU) PCB are coupled, are provided in the main body 110. In addition, one or more ports, into which an Ethernet cable and a USB cable are connected, are provided in the main body 110. The ports are selectively opened and closed by a cover 115.

In addition, the main body 110 is provided with a display unit 113 for displaying the operational state of the main body 110. The display unit 113 may be a light emitting diode (LED) lamp for simply displaying the operational state of the main body 110, such as “error” or “run”. Alternatively, a display panel may be used.

A male port 111 is disposed at one side surface of the main body 110, i.e. the side surface of the main body 110 to which the communication unit 120 is coupled. When the communication unit 120 is coupled to one side surface of the main body 110, therefore, a female port disposed at a corresponding side surface of the communication unit 120 is coupled to the male port 111 of the main body 110. Hereinafter, the male port 111 will be described as being disposed at one side surface of the main body 110 or the communication unit 120, and the female port will be described as being disposed at a corresponding side surface of the communication unit 120 or the main body 110. Alternatively, the female port may be disposed at one side surface of the main body 110 or the communication unit 120, and the male port 111 may be disposed at a corresponding side surface of the communication unit 120 or the main body 110. Serial (9-pin) ports may be used as the male port and the female port.

A fastening unit 140 is provided at the lower surface of the main body 110 such that the main body 110 can be temporarily fixed to a predetermined installation position in the power device. The fastening unit 140 is provided at the lower surface of the main body 110 so as to be elastically slidable. When the user fastens the main body 110 to the installation position, therefore, the position of the main body 110 is temporarily fixed due to the elasticity of the fastening unit 140. In this state, the user may securely and completely fix the main body 110 to the installation position using a spanner. Of course, the fastening unit 140 may achieve sufficient fixation using the elastic coupling force thereof. Consequently, the main body 110 may be easily fixed to the installation position by the fastening unit 140.

The fastening unit 140 includes a transfer member 141 coupled to the lower surface of the main body 110 so as to be slidable, an elastic member 142 for restoring the sliding state of the transfer member 141, and a fixing member 143 for fixing the transfer member 141 and the elastic member 142 to the lower surface of the main body 110 in the state in which the transfer member 141 and the elastic member 142 are coupled to each other. In addition, the fastening unit 140 further includes a fastening member 144 disposed opposite the transfer member 141 for providing coupling force on the lower surface of the main body 110 together with the transfer member 141. The fastening member 144 is coupled to the installation position, and the transfer member 141 slides to fix the main body 110. When the fixation of the main body 110 is completed, the transfer member 141 returns to the original position thereof.

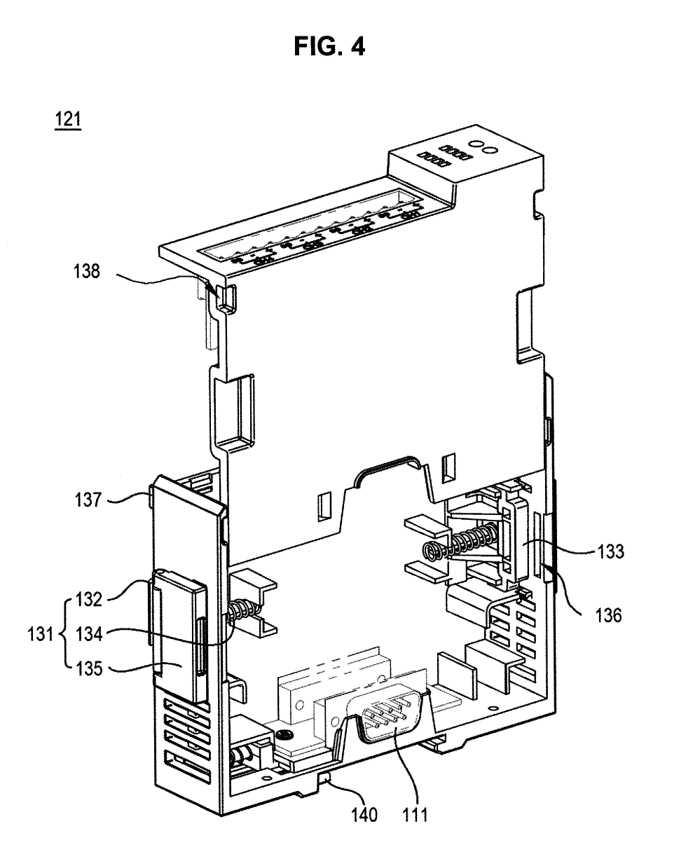

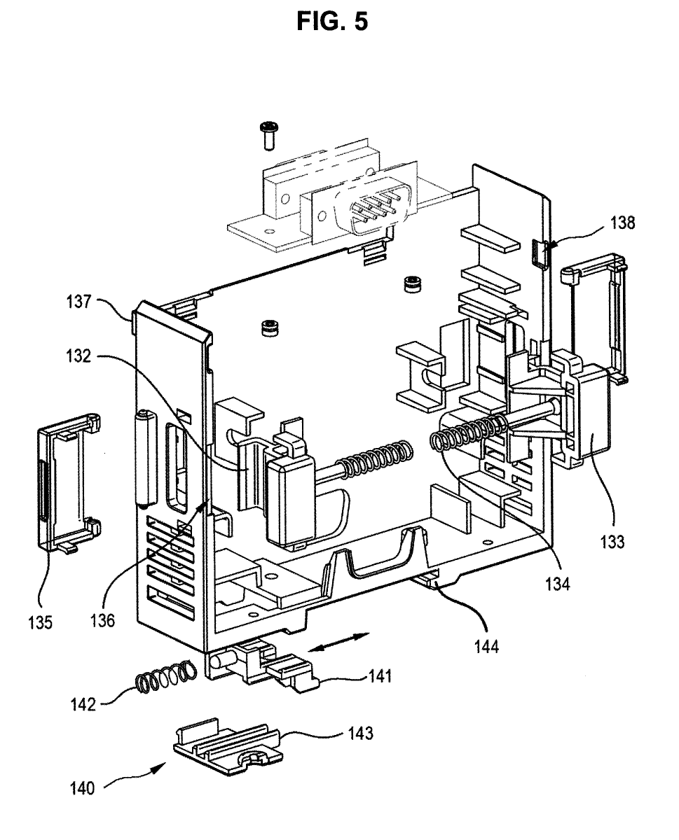

FIG. 4 is a reference view showing the interior of a portion of the communication unit of the IoT integrated type data processor for interfacing with wired and wireless facilities shown in FIG. 1, and FIG. 5 is an exploded view showing the portion of the communication unit of the IoT integrated type data processor for interfacing with wired and wireless facilities shown in FIG. 1.

Referring to FIGS. 4 and 5, the communication unit includes a first communication module 121 to a fifth communication module 125. The same reference numerals as the above-mentioned reference numerals indicate the same components.

The first to fifth communication modules 121 to 125 perform different functions but have similar appearances. In addition, the first to fifth communication modules 121 to 125 are coupled to or separated from each other in the same manner. Consequently, a duplicate description of the first to fifth communication modules 121 to 125 will be omitted, but only the coupling and separation therebetween and the operation and effects thereof will be described in detail.

The coupling unit 130 is provided between the main body 110 and the communication unit 200 or between one communication module and another communication module. Consequently, the coupling unit 130 couples the main body 110 and the communication unit 200 to each other in the lateral direction. In addition, the coupling unit 130 couples each communication module and a neighboring communication module to each other in the lateral direction.

The coupling unit 130 includes a hook unit 131 protruding from one side surface of the main body 110 or each communication module and a coupling recess 136 formed in a corresponding side surface of each communication module or the main body 110 such that the hook unit 131 is fastened into the coupling recess 136.

The hook unit 131 includes a hook member 132 protruding toward the coupling recess 136, a button member 133 for slidably moving the hook member 132 such that the hook member 132 is coupled into the coupling recess 135 or separated from the coupling recess 135, a coil spring 134 for restoring the sliding state of the button member 133, and a cover member 135 for covering the button member 133 such that the button member 133 can be pushed only when the hook member 132 is to be coupled into the coupling recess 135 or is to be separated from the coupling recess 135.

The hook unit 131 is provided at each side of one side surface of the main body 110 or each communication module. Consequently, the user may slide the hook member 132 while pushing the button member 133 at each side surface of the main body 110 or each communication module such that the hook member 132 is coupled into or separated from the coupling recess 136 formed in each side of the other side surface of the main body 110 or each communication module. Alternatively, the hook member 132 may have an inclined end such that the hook member 132 can be coupled into the coupling recess 136 without pushing the button member 133.

The coupling unit 130 includes a guide member 137 protruding from one side surface of the main body 110 or each communication module and a guide recess 138 formed in a corresponding side surface of each communication module or the main body 110 such that the guide member 137 is inserted into the guide recess 138. When the user couples the main body 110 and the communication unit 120 to each other or couples each communication module and a neighboring communication module to each other, the guide member 137 formed at one side surface of the main body 110 is inserted into the guide recess 138 formed in a corresponding side surface of the communication unit 120, or the guide member 137 formed at one side surface of each communication module is inserted into the guide recess 138 formed in a corresponding side surface of a neighboring communication module. Consequently, the fastening force between the hook unit 131 and the coupling recess 126 is maintained, and the coupling therebetween is guided by the guide member 137 and the guide recess 138, whereby the coupling of the coupling unit 130 is maintained in a correct direction and at a correct angle.

In addition, a fastening unit 140 identical to the fastening unit 140 of the main body 110 is provided at the lower surface of each communication module. The fastening unit 140 includes a transfer member 141 coupled to the lower surface of each communication module so as to be slidable, an elastic member 142 for restoring the sliding state of the transfer member 141, and a fixing member 143 for fixing the transfer member 141 and the elastic member 142 to the lower surface of each communication module in the state in which the transfer member 141 and the elastic member 142 are coupled to each other. In addition, the fastening unit 140 further includes a fastening member 144 disposed opposite the transfer member 141 so as to correspond to the transfer member 141 at the lower surface of each communication module. The fastening member 144 is coupled to the installation position, and the transfer member 141 slides to fix each communication module. When the fixation of each communication module is completed, the transfer member 141 returns to the original position thereof.

Even in the state in which the main body 110 and each communication module are coupled to each other, therefore, the main body 110 and each communication module may be integrally fastened to the installation position in the power device using the fastening unit 140, thereby achieving easy coupling.

In the same manner as in the main body 110, each communication module is provided with a display unit 113 for displaying the operational state of each communication module. The display unit 113 may simply display the operational state of each communication module, such as “error” or “run”.

As is apparent from the above description, the IoT integrated type data processor for interfacing with wired and wireless facilities according to the present invention has the following effects.

First, it is possible for the user to recognize the inner state of the power device in real time, whereby it is possible to rapidly respond to an emergency.

Second, it is possible to selectively use the communication modules depending on the location of the power device and the distance between the power device and the user, whereby it is possible to reduce expenses.

Third, it is possible to selectively adapt to the user's environment by varying the kinds of communication modules that are included, whereby it is possible to improve assemblability.

Fourth, it is possible for the data processor to be easily coupled to or separated from the power device or to achieve easy coupling or separation between the main body and the communication unit.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An IoT integrated type data processor for interfacing with wired and wireless facilities, the IoT integrated type data processor comprising:
a main body, to which external power and data cables are connected;
a communication unit selectively coupled to the main body for wirelessly transmitting and receiving data; and
a coupling unit for seperably coupling the main body and the communication unit to each other or seperably coupling communication modules constituting the communication unit to each other.

2. The IoT integrated type data processor according to claim 1, wherein the main body is mounted in a power device to receive data, such as information about temperature, humidity, arcs, current, voltage, fire, and earthquakes in the power device and to transmit the data to the communication unit.

3. The IoT integrated type data processor according to claim 1, wherein the communication unit comprises at least one selected from among:
a first communication module using one selected from among an RS-232 interface, an RS-422 interface, and an RS-485 interface;
a second communication module using a Wireless-Fidelity (Wi-Fi) interface;
a third communication module using a Code Division Multiple Access (CDMA) interface;
a fourth communication module using a Bluetooth interface; and
a fifth communication module using a ZigBee interface.

4. The IoT integrated type data processor according to claim 3, wherein the coupling unit comprises:
a hook unit protruding from one side surface of one selected from between the main body and any one of the communication modules; and
a coupling recess formed in a corresponding side surface of the other selected from between the main body and any one of the communication modules such that the hook unit is fastened into the coupling recess.

5. The IoT integrated type data processor according to claim 4, wherein the hook unit comprises:
a hook member protruding toward the coupling recess;
a button member for slidably moving the hook member such that the hook member is coupled into the coupling recess or separated from the coupling recess; and
a cover member for covering the button member such that the button member can be pushed only when the hook member is to be coupled into the coupling recess or is to be separated from the coupling recess.

6. The IoT integrated type data processor according to claim 4, wherein the coupling unit comprises:
a guide member protruding from one side surface of one selected from between the main body and any one of the communication modules; and
a guide recess provided in a corresponding side surface of the other selected from between the main body and any one of the communication modules for guiding coupling between the main body and any one of the communication modules.

7. The IoT integrated type data processor according to claim 6, further comprising:
a female port provided at one side surface of one selected from between the main body and any one of the communication modules; and
a male port provided at a corresponding side surface of the other selected from between the main body and any one of the communication modules such that the male port is coupled to the female port, wherein
when the guide member is coupled into the guide recess, the male port is simultaneously connected to the female port.

8. The IoT integrated type data processor according to claim 4, wherein each of the main body and the communication modules comprises a fastening unit provided at a lower surface thereof such that each of the main body and the communication modules is temporarily fixed to an installation position.

9. The IoT integrated type data processor according to claim 8, wherein the fastening unit is configured to integrally fasten the main body and the communication modules, integrally coupled to each other through the coupling unit, to the installation position.

10. The IoT integrated type data processor according to claim 3, wherein each of the main body and the communication modules comprises a display unit for displaying an operable state or an inoperable state thereof.

11. The IoT integrated type data processor according to claim 1, wherein the main body is configured to receive data transmitted to the communication unit from an outside and to transmit a control signal corresponding thereto to a controller.
